(19) United States
(12) Patent Application Publication
(10) Pub. No.: US 2016/0247116 A1
(43) Pub. Date: Aug. 25, 2016

(54) METHOD AND APPARATUS FOR WAREHOUSE CYCLE COUNTING USING A DRONE

(71) Applicant: DRONEWARE TECHNOLOGY CORPORATION, ATLANTA, GA (US)

(72) Inventors: CRAIG OLIVO, ATLANTA, GA (US); MICHAEL BUZAKI, PEMBROKE PINES, FL (US)

(21) Appl. No.: 15/013,029

(22) Filed: Feb. 2, 2016

Related U.S. Application Data
(60) Provisional application No. 62/118,440, filed on Feb. 19, 2015.

(51) Int. Cl. G06Q 10/08; B64D 47/08; B64C 39/02; H04N 7/18; H04N 5/44

(52) U.S. Cl. CPC G06Q 10/087; H04N 7/185; H04N 5/44; B64C 39/024; B64D 47/08; B64C 2201/127

(57) ABSTRACT

A method for cycle counting warehouse inventory using a drone system with a drone carrying a scanning device and a computer with an RF session receiving cycle count tasks. The drone system is placed within a flight range of the drone to a cycle count location and flown to the cycle count location of the cycle count task. The drone acquires the inventory location data and sends it to a warehouse management system through the RF session. Then the drone acquires the inventory data and sends it to a warehouse management system through the RF session. If prompted by the warehouse management system, further data are acquiring such as SKU data, LPN attribute information, and/or quantity information.

### CROSS-REFERENCE TO RELATED APPLICATION

This application claims the priority, under 35 U.S.C. § 119(e). of provisional application No. 62/118,440 filed Feb. 19, 2015; the prior application is herewith incorporated by reference in its entirety.

### BACKGROUND OF THE INVENTION

### Field of the Invention:

The present invention relates to a method of cycle counting inventory at distribution centers or warehouses. Cycle counting is the process of auditing inventory at distribution centers or warehouses. In a cycle count, a section of the inventory in a specific location of a warehouse is counted to measure inventory accuracy relative to the records in the warehouse management system (WMS). Contrary to physical inventory, cycle counting requires only the section being cycle counted to be measured, as opposed to physical inventory where the full inventory of the warehouse is measured during a time in which the operation of the warehouse would be stopped.

Distribution center and warehouse inventory is conventionally stored by two basic types of location, a rack location and a floor location. Rack locations are vertical structures that store inventory such as pallets, cartons, or units above the floor. There are multiple locations in a single rack and each location is labeled with a number that corresponds to a location configured in a warehouse management system (WMS). Floor locations consist of a designated space on a warehouse or distribution center floor where inventory is stored. Inventory can be stacked on top of each other within a single floor location.

Typical cycle counting in distribution centers and warehouses is accomplished by a user receiving a cycle counting task from the warehouse management system (WMS) or a user-generated report of the locations needed to be cycle counted then going to the section needed to be cycle counted with an RF gun and a forklift or lift truck. Cycle count tasks will be assigned to users based on a previously determined configuration with in the warehouse management system (WMS), or a manual user-generated report based on inventory and/or location data from the warehouse management system (WMS). To cycle count rack locations, the user moves pallets with inventory off the racks to ground level using a forklift at which point they would scan a pallet barcode or manually count the inventory. An alternative method to cycle count rack locations is to hoist the user to pallet locations using a lift truck where the user would scan a pallet barcode or manually count the inventory. To cycle count floor locations, an aisle needs to be left between each floor location in order for a user to be able to cycle count each pallet or the pallets need to be moved to an open area and then cycle counted.

Although there is benefit to cycle counting, there are many drawbacks to the classical cycle counting process. Unnecessary movement of material can cause damage to the inventory, forklift/lift truck or rack. Labor time and cost can consume resources, it takes an average of five minutes to cycle count rack locations and up to eight hours to cycle count floor locations, as well as entire aisles being shut down to prevent other activities including picking orders. There is a risk of injury to personnel as they use a lift truck or move inventory. As well as the material cost of forklifts, lift trucks and maintenance. Allotted space for floor location cycle counts causes low utilization of floor space which allows for less volume for inventory. While cycle counting can verify inventory accuracy, quarterly, bi-yearly, yearly physical counts that shut down the entire distribution center or warehouse are still needed.

### SUMMARY OF THE INVENTION

It is accordingly an object of the invention to provide an apparatus and a method of warehouse cycle counting using a drone which overcomes the above-mentioned and other disadvantages of the heretofore-known devices and methods of this general type and which reduces the need for unnecessary movement of inventory, decreases the cycle count times and labor costs, decreases the injury liability from heavy lifting equipment, and decreases loss for damage materials, while at the same time increasing the inventory accuracy rates, reducing the need for full physical counts of inventory, and increasing the utilization of bulk locations.

With the foregoing and other objects in view there is provided, in accordance with the invention, method of warehouse cycle counting. The method comprises the following steps:
providing a drone system with a drone carrying a scanning device selected from the group consisting of a barcode scanner, video feed, image recognition, and RFID scanner, and a computer with an RF session;
receiving, by the computer, a cycle count task on the RF session;
placing the drone system within a flight range of the drone to a cycle count location;
flying the drone to the cycle count location of the cycle count task; acquiring inventory location data using the scanning device; sending the inventory location data to a warehouse management system (WMS) via the RF session;
acquiring inventory data at the inventory location using the scanning device;
sending the inventory data to the WMS via the RF session;
if prompted by the WMS, acquiring further data selected from the group consisting of SKU data, LPN attribute information, and quantity information.

Using a drone for cycle counting in the above method reduces the need to unnecessarily move the inventory which can cause damage to the inventory, forklift or rack. By using a drone, the reduced times needed to cycle count reduce labor cost which consume resources. The risk of personnel injury due to the operation of for lifts and lift trucks is removed from cycle counting, as well as injury from moving inventory. Warehousing costs can be reduced by removing the need for frequent use and maintenance of forklifts, lift trucks. Because of the ease and reduced costs of cycle counting using the drone for inventory, cycle counting can be done more frequently to increase inventory accuracy, and with a higher accuracy in inventory, a warehouse can reduce the frequency of physical counts that shut down the entire distribution center or warehouses.

In accordance with an added feature of the invention, the receiving step comprises receiving the cycle count task from the WMS and/or non-WMS system or process to generate a report. A non-WMS system can be any system or process with access to WMS data through the WMS user interface and/or WMS data base that generates cycle counting tasks. A non-WMS system or third party system can consist of a database tool used to extract inventory data to generate a cycle count task. For example, a user could query the inventory information in the WMS data base and export that inventory data to excel to generate a report of locations to cycle count.

In accordance with an additional feature of the invention, the inventory data is interfaced into the WMS via RF prompts, staging tables, XML, socket (TCP/IP), file transfer protocol (FTP), or flat file.

In accordance with another feature of the invention, the physical condition of the inventory or other materials is inspected by viewing the physical condition of inventory or other materials in a warehouse via video streamed from a camera on the drone. During a cycle count task, the camera used for scanning or to fly the drone can also be used to inspect the inventory of warehouse material for their condition.

In accordance with a further feature of the invention, the method further comprises taking a photograph of identifier information initiated at the controller or automatically as the scanning device scans the identifier information, and storing the image. By taking a picture of the identifier an storing the image, an audit of the cycle counting information can be made once the cycle count task has completed.

In accordance with yet an added feature of the invention, a video stream of a drone flight path is stored or broadcasted on the computer. Storing the flight path of the drone can be used for auditing the cycle counting process as well as training further users and supervising the drone use of the user.

In accordance with yet an additional feature of the invention, the scanned inventory location and inventory data is stored as a spreadsheet format file on the computer. An example of a spreadsheet format file would be a .csv or excel file.

In accordance with yet a further feature of the invention, the warehouse cycle counting operation is directed with a cycle counting software system configured to:
determine which warehouse locations should be cycle counted;
receive data points of cycle counting tasks from the WMS or from a user-generated report;
assign each location a rank based on the received data points; and creates a report for which locations in the warehouse should be cycle counted.

In accordance with yet again an added feature of the invention, the warehouse cycle counting system is controlled with a cycle counting algorithm system configured to:
determine which warehouse locations should be cycle counted;
generate a cycle counting report from cycle counting software;
send a report to the WMS to generate cycle counting tasks for a user;
generate in the WMS cycle counting tasks that are assigned to users; and
causing a user to conduct the cycle counting tasks in the warehouse.

For example, the cycle counting algorithm can use historical data to determine the locations to cycle count based off of when the location was last counted, error rate, frequency of cycle counting of that location, and cost of product.

With the above and other features in view there is also provided, in accordance with the invention, an apparatus for warehouse cycle counting comprising:
a drone system with a drone and a computer;
the drone having an onboard computer, a flight controller, electronic speed controllers, and a battery;
the onboard computer having a scanning device selected from the group consisting of a barcode scanner, video feed, image recognition, and RFID scanner, a camera, a wireless transceiver or Bluetooth device, and a memory for identifier information storage;
the flight controller having proximity sensors the electronic speed controllers (ESC) connecting to motors that propel the drone;
the battery powering the ESC, flight controller, and onboard computer;
the computer having drone software, a controller, and a wireless transceiver for communication with the drone and a warehouse management system (WMS); and
the drone software having flight software, a video feed, and an RF session.

In accordance with an added feature of the invention, the drone system comprises a cart having a drone landing pad. Using a cart to move the drone system to cycle count locations and a landing pad for the drone allows for the compact and easy movement of the drone system. It would also reduce the need for the user to physically interact with the drone, thus reducing the risk of injury.

In accordance with an additional feature of the invention, the drone comprises propellers and guards around the propellers. Using guards around the propellers of the drone reduces the possibility of the drones, inventory, personnel, or surrounding being damaged during use.

In accordance with another feature of the invention, the drone comprises LED lights to illuminate inventory and inventory location identifiers. The lights on the drone allows the drone scanning device to see identifiers regardless of lighting and shadows in the warehouse.

In accordance with a further feature of the invention, the computer has custom software configured for communication between said drone, the WMS, and a network.

In accordance with yet an added feature of the invention, the drone system comprises a cycle counting software system configured to:
determine which warehouse locations should be cycle counted;
receive data points of cycle counting tasks from the WMS or from manual input;
assign each location a rank based on the received data points; and creates a report for which locations in the warehouse should be cycle counted.

In accordance with a concomitant feature of the invention, the drone system comprises a cycle counting algorithm system configured to:
determine which warehouse locations should be cycle counted;
generate a cycle counting report from cycle counting software;
send a report to the WMS to generate cycle counting tasks for a user;
generate in the WMS cycle counting tasks that are assigned to users; and
causing a user to conduct the cycle counting tasks in the warehouse.

The drone is controlled from the ground by a computer that communicates with a micro-computer onboard the drone, via a network. The drone utilizes a video feed, a barcode scanner, or an RFID Scanner that is attached to the drone and has the ability to scan and/or read barcodes, RFID tags, and various identifiers. By utilizing the flying drone, already existing warehouse management systems (WMS), custom software, and the methods in which a user typically interacts with a WMS system including RF Sessions via a telnet or web session connection. The various identifier scans (such as barcode or RFID scans) that are necessary to complete inventory control tasks are now completed using a drone that communicates with the resident WMS system. The drone replaces forklifts or lift trucks that are currently used in the cycle counting process and can interact with a warehousing current WMS.

The drone needed to complete the method can be made from basic parts easily found in the market place. By way of example, a basic IRIS drone manufactured by 3DRobotics as well or homemade drone can be supplied with the various parts necessary for the inventive purpose. A Raspberry Pi 2 computer can be configured with a barcode reader/scanner module made by Adafruit, along with a Raspberry PI 5 MP Camera Board Module. A standard laptop may be used to communicate with the Raspberry Pi 2 and a joystick to fly the drone. The laptop can have installed APM Mission Planner, and an RF session.

Additionally custom software can be used to integrate the flight control software with the flight controller and Raspberry Pi 2 to capture scans and send/populate them into the RE Session. The user loads and initiates the custom program on the laptop to bring up the RF session, APM Mission Planner, and video of the camera. After signing into the RF session, the user is given cycle counting tasks from the WMS. After walking the drone system of the drone and computer system, the user flies the drone using the joystick connected to the laptop to the cycle count location given by the WMS and initiates the scans per the RF session instructions by pressing a button on the joystick. The scanned information is sent from the Raspberry Pi 2 to the RF session over wireless network, Wifi Direct, Ad-Hoc Connection, or Bluetooth. Once populated in the RF session, the information is automatically sent to the WMS for processing.

Other features which are considered as characteristic for the invention are set forth in the appended claims.

Although the invention is illustrated and described herein as embodied in method of warehouse cycle counting using a drone, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a flow chart of the steps used to complete a cycle count in the prior art.

FIG. 2 is a flow chart of the steps used in an embodiment of a method of warehouse cycle counting using a drone.

FIG. 3 is a flow chart of the steps used to complete a cycle count in the prior art.

FIG. 4 is a flow chart of the steps used in an embodiment of a method of warehouse cycle counting using a drone.

FIG. 5 is a flow chart of the steps used to complete a cycle count in the prior art.

FIG. 6 is a flow chart of the steps used in an embodiment of a method of warehouse cycle counting using a drone.

FIG. 7 is a flow chart of the steps used to complete a cycle count in the prior art.

FIG. 8 is a flow chart of the steps used in an embodiment of a method of warehouse cycle counting using a drone.

FIG. 9 is a flow chart of the steps used to complete a cycle count in the prior art.

FIG. 10 is a flow chart of the steps used in an embodiment of a method of warehouse cycle counting using a drone.

FIG. 11 is a Dow chart of the steps used to complete a cycle count in the prior art.

FIG. 12 is a flow chart of the steps used in an embodiment of a method of warehouse cycle counting using a drone.

FIG. 13 is a flow chart of the steps used to complete a cycle count in the prior art.

FIG. 14 is a flow chart of the steps used in an embodiment of a method of warehouse cycle counting using a drone.

FIG. 15 is a flow chart of the steps used to complete a cycle count in the prior art.

FIG. 16 is a flow chart of the steps used in an embodiment of a method of warehouse cycle counting using a drone.

FIG. 17 is a flow chart of the steps used to complete a cycle count in the prior art.

FIG. 18 is a flow chart of the steps used in an embodiment of a method of warehouse cycle counting using a drone.

FIG. 19 is a schematic of components of a drone used for a method of warehouse cycle counting using a drone.

FIG. 20 is a schematic of components of a drone, computer, WMS, and surrounding elements used for a method of warehouse cycle counting using a drone.

FIG. 21 is a schematic of components of a computer and WMS used for a method of warehouse cycle counting using a drone.

FIG. 22 is a schematic of components of a drone and computer used for a method of warehouse cycle counting using a drone.

FIG. 23 is a schematic of components of a drone and surrounding elements used for a method of warehouse cycle counting using a drone.

FIG. 24 is a schematic of components of a drone, computer, and surrounding elements used for a method of warehouse cycle counting using a drone.

FIG. 25 is a schematic of components of a drone, computer and surrounding elements used for a method of warehouse cycle counting using a drone.

FIG. 26 is a schematic of components of a drone used for a method of warehouse cycle counting using a drone.

FIG. 27 is a diagram of drone communication during a method of warehouse cycle counting using a drone.

FIG. 28 A-D is a prior art diagram of a process of cycle counting using a lift truck.

FIG. 29 A-E is a prior art diagram of a process of cycle counting using a fork lift.

FIG. 30 A-D is a diagram of a process of cycle counting using a drone.

### DETAILED DESCRIPTION OF THE INVENTION

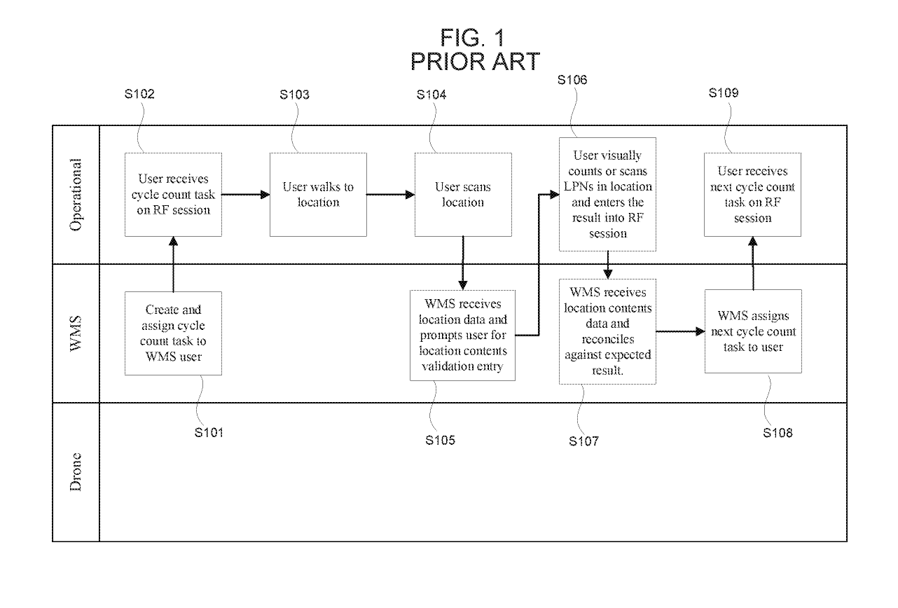

Referring now to the figures of the drawing in detail and first, particularly, to FIG. 1 thereof, there is shown a prior art illustration of a cycle counting process. In step S101 the warehouse management system (WMS) creates and assigns a cycle count task to a WMS user. In step S102 the user receives the cycle count task on an RF session (RF gun or scanner). In step S103 the user walks to the location of the cycle counting task, and in step S104 scans the location. In step S105 the WMS receives location data from the user scan and prompts the user for location contents validation entry. In step S106 the user either visually count or scans the LPNs in that location and enters the result into RF session. In step S107 the WMS receives the location contents data and reconciles against an expected result. In step S108 the WMS assigns the next cycle count task to the user, where in step S109 the user receives the next cycle count task on RF session.

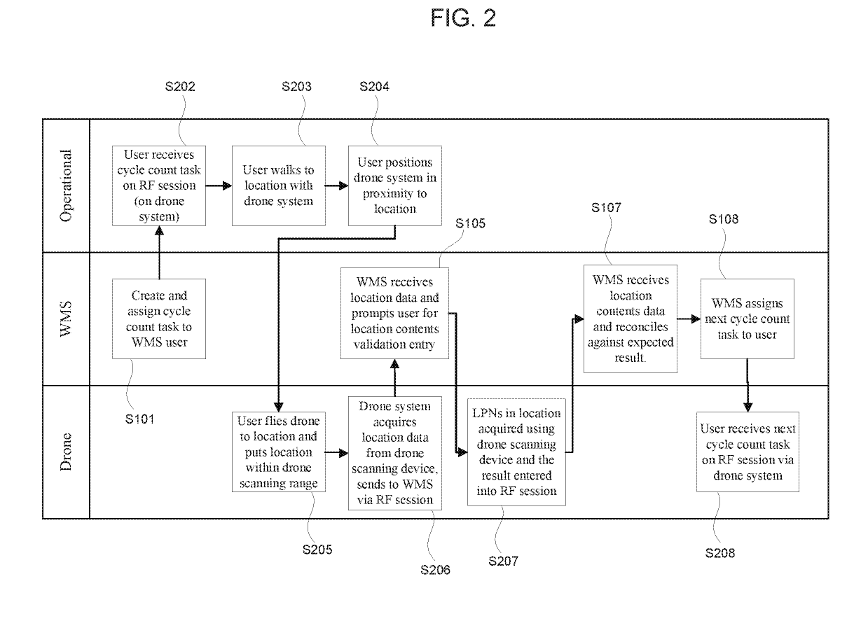

FIG. 2 is a first embodiment of the method of warehouse cycle counting using a drone. In step S101 the WMS creates and assigns a cycle count task to a WMS user. In step S202 the user receives the cycle count task on RF session on drone system; the task will display the location in the warehouse to be cycle counted. In step S203 the user walks to the cycle count location with the drone system. In step S204 the user positions drone system in proximity to location. In step S205 the user flies drone to the location identifier and puts the location identifier within drone scanning range. In step S206 the drone system acquires location data from drone scanning device and then sends the location data to WMS via RF session. In step S105 the WMS receives location data and prompts the user for the location contents validation entry. In step S207 the LPNs in location are acquired using the drone scanning device and the resulting data is entered into RF session. In step S107 the WMS receives location contents data and reconciles against an expected result. In step S108 the WMS assigns a next cycle count task to the user and in step S208 the user receives the next cycle count task on RF session via the drone system.

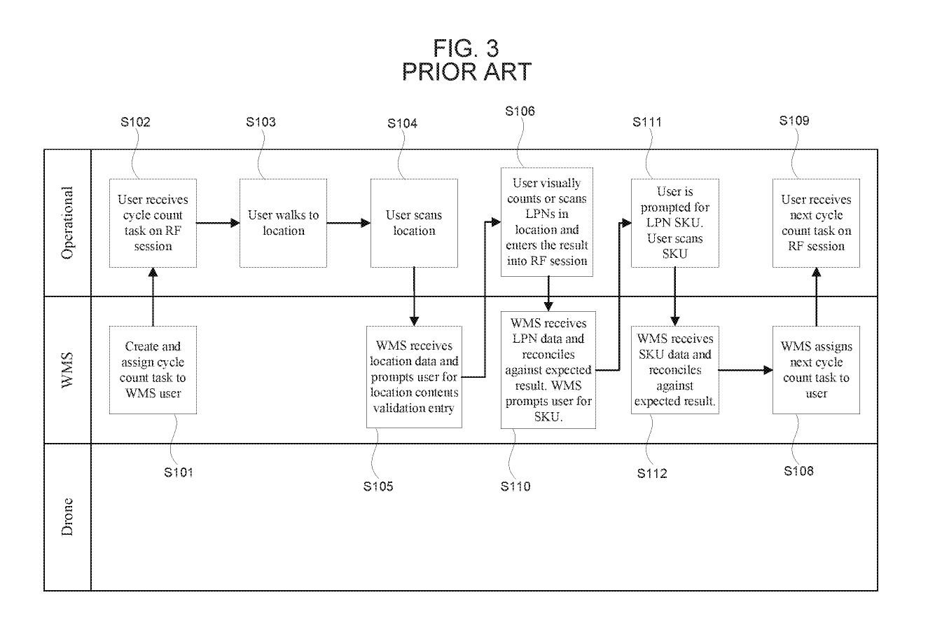

FIG. 3 is a prior art illustration of a cycle counting process. In step S101 the WMS creates and assigns a cycle count task to the WMS user. In step S102 the user receives the cycle count task on the RF session. In step 5103 the user walks to location, where in step S104 the user scans the location. In step S105 the WMS receives location data and prompts user for location contents validation entry, where in step S106 the user visually counts or scans LPNs in location and enters the result into the RF session. In step S110: the WMS receives the LPN data scanned by the user and reconciles it against an expected result; the WMS will then prompt the user for an SKU scan. In step S111 the user is prompted and scans the LPN's SKU. In step S112 the WMS receives the SKU data and reconciles against an expected result. In step S108 the WMS assigns a next cycle count task to the user, where in step S109 user receives the next cycle count task on the RF session.

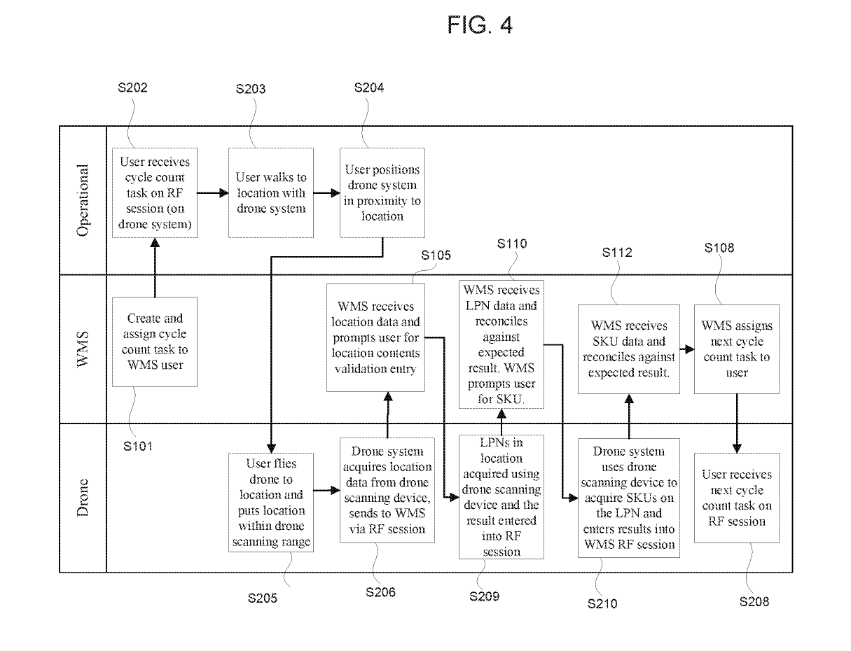

FIG. 4 is a second embodiment of the method of warehouse cycle counting using a drone. In step S101 the WMS creates and assigns a cycle count task to the WMS user. In step S202 the user receives the cycle count task on the RF session on the drone system; the task will display the location in the warehouse to be cycle counted. In step S203 the user walks to the location with the drone system, and in step S204 the user positions the drone system in proximity to the location. In step S205 the user flies the drone to location identifier and puts location identifier within drone scanning range. In S206 the drone system acquires the location data from the drone scanning device and sends the data to the WMS via the RF session. In step S105 the WMS receives the location data and prompts the user for location contents validation entry, where in step S209 the LPNs in the location are acquired using drone scanning device and the result entered into RF session. In step S110 the WMS receives the scanned LPN data and reconciles against an expected result, then the WMS will prompt the user for an SKU scan. In S210 the drone scanning device acquires SKUs on the LPN and enters results into WMS RF session. In step S112 the WMS receives the SKU data and reconciles against an expected result. In step S108 the WMS assigns a next cycle count task to user and in step S208 the user receives the next cycle count task on RF session via the drone system.

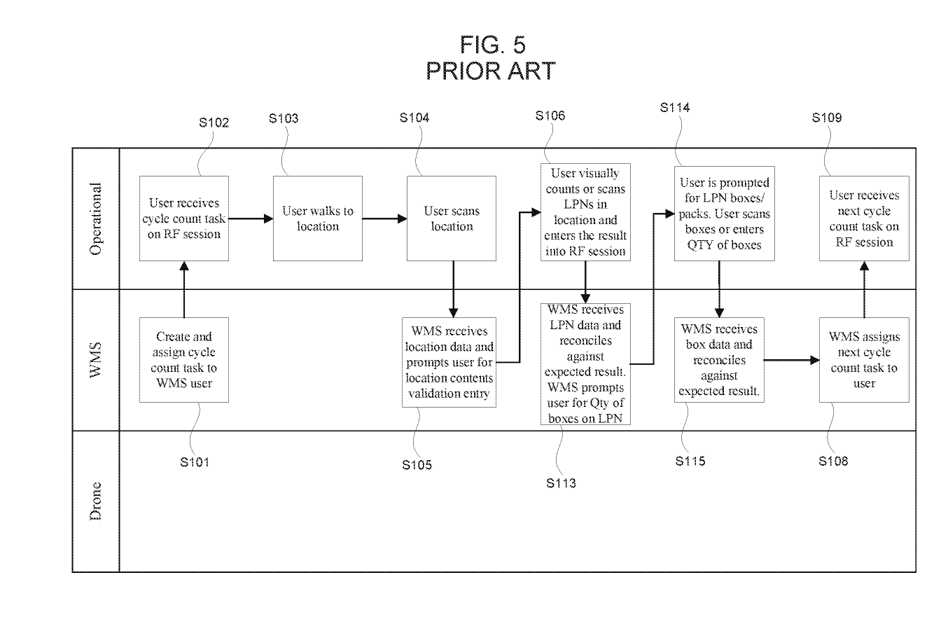

FIG. 5 is a prior art illustration of a cycle counting process. In step S101 the WMS creates and assigns a cycle count task to the WMS user. In step S102 the user receives the cycle count task on the RF session. In steps S103 and S104 the user walks to location and then scans the location. In step S105 the WMS receives the location data and prompts the user for location contents validation entry, where in S106 the user visually counts or scans LPNs in the location and enters the result into the RF session. In step S113 the WMS receives LPN data and reconciles against an expected result, the WMS then prompts the user for a quantity of boxes on the LPN. In step S114 the user is prompted to enter the LPN boxes/packs data; the user then scans the boxes or enters quantity of boxes. In step S115 the WMS receives the box/quantity data and reconciles against an expected result. In step S108 the WMS assigns a next cycle count task to user, and in step S109 the user receives the next cycle count task on the RF session.

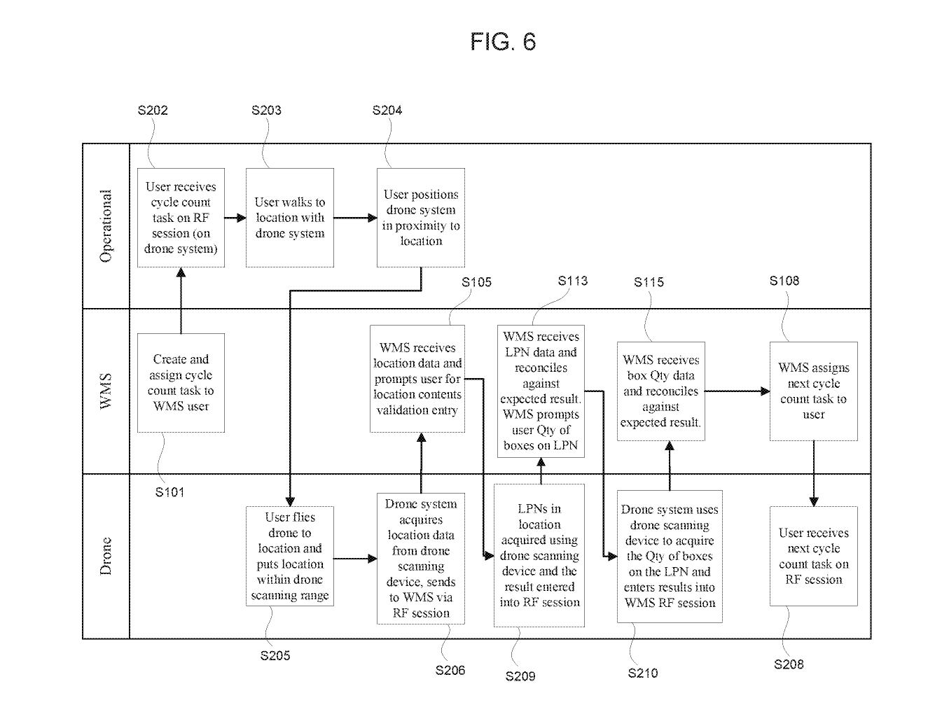

FIG. 6 is a further embodiment of the method of warehouse cycle counting using a drone. In step S101 the WMS creates and assigns a cycle count task to the WMS user. In step S202 the user receives the cycle count task on the RF session on the drone system. In step S203 the user walks to location with drone system and in step S204 the user positions the drone system in proximity to the location. In step S205 the user flies the drone to the location identifier and puts location identifier within drone scanning range. In step S206 the drone system acquires the location data from the drone scanning device and sends the data to the WMS via the RF session. In step S105 the WMS receives the location data and prompts the user for location contents validation entry. In step S209 the LPNs in the location are acquired using the drone scanning device and the result is entered into the RF session. In step S113 the WMS receives the LPN data scanned into the RF session and reconciles against an expected result and the WMS prompts the user for the quantity of boxes on the LPN. In step S210 the drone scanning device acquires the quantity of boxes/packs on the LPN and enters results into WMS RF session. In step S115 the WMS receives box/pack data and reconciles against an expected result. In step S108 the WMS assigns a next cycle count task to user and in step S208 the user receives the next cycle count task on the RF session via drone system.

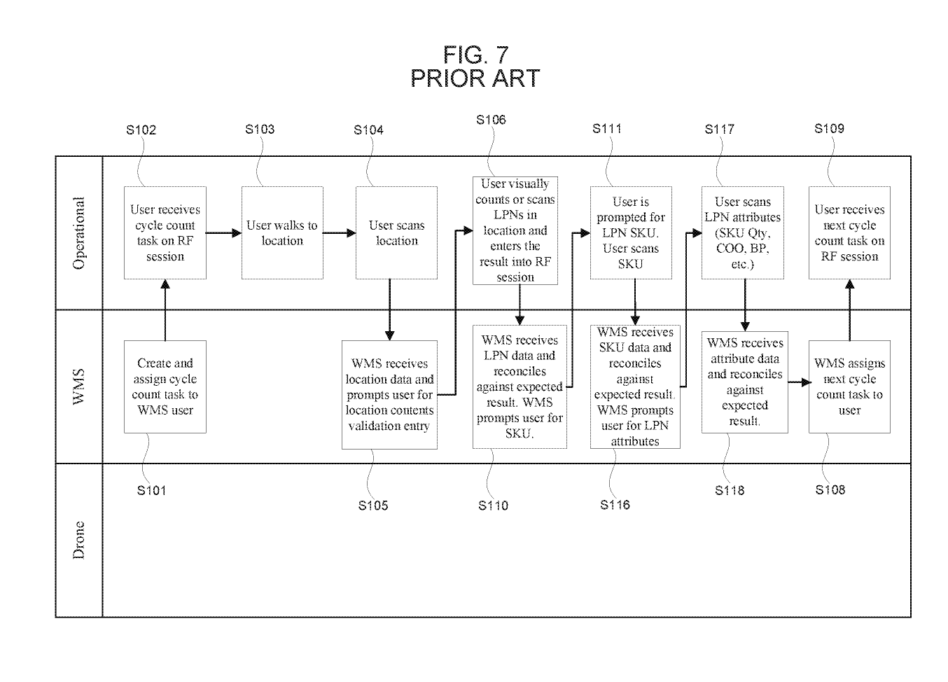

FIG. 7 is a prior art illustration of a cycle counting process. In step S101 the WMS creates and assigns a cycle count task to the WMS user. In step S102 the user receives the cycle count task on the RF session. In step S103 the user walks to the location and in step S104 the user scans location. In step S105 the WMS receives the location data and prompts the user for location contents validation entry. In step S106 the user visually counts or scans the LPNs in the location and enters the result into RF session. In step S110 the WMS receives the LPN data and reconciles against an expected result and then the WMS prompts the user for an SKU scan. In step S111 the user is prompted and scans for the LPN's SKU. In step S116 the WMS receives the SKU data and reconciles against an expected result, the WMS then prompts the user for LPN attributes data. In step S117 the user scans the LPN attributes data (SKU Qty, COO, BP, etc.). In step S118 the WMS receives the LPN attribute data and reconciles against an expected result. In step S108 the WMS assigns a next cycle count task to user and in step S109 the user receives the next cycle count task on the RF session.

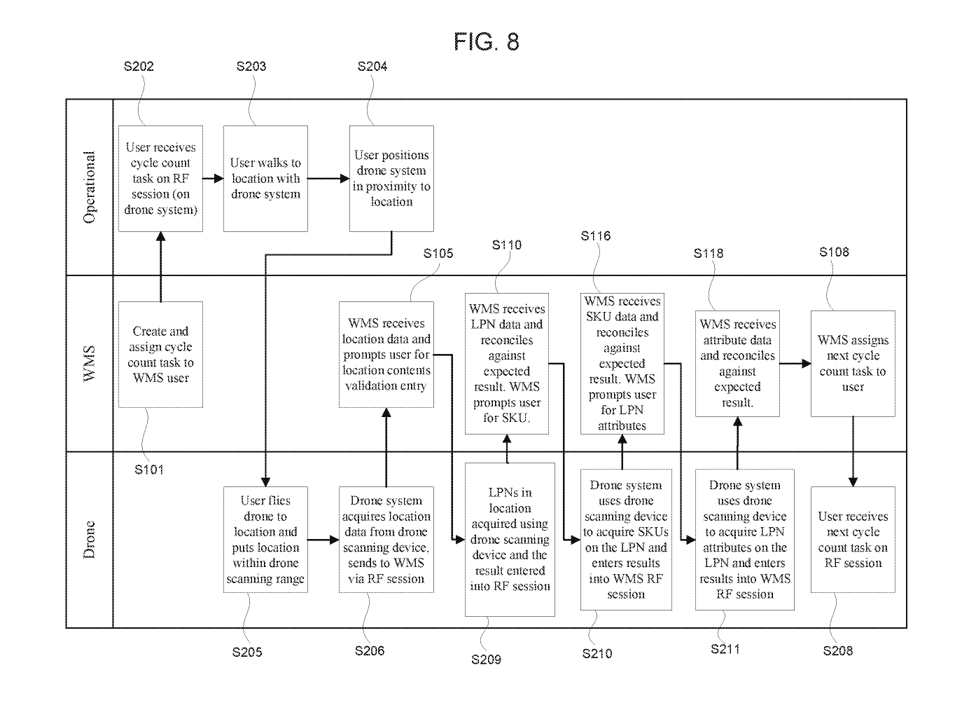

FIG. 8 is a further embodiment of the method of warehouse cycle counting using a drone. In step S101 the WMS creates and assigns a cycle count task to the WMS user. In step S202 the user receives the cycle count task on then RF session on the drone system; the task will display the location in the warehouse to be cycle counted. In step S203 the user walks to the location with the drone system and in step S204 the user positions the drone system in proximity to location. In step S205 the user flies the drone to the location identifier and puts location identifier within drone scanning range. In step S206 the drone system acquires location data from drone scanning device and sends the data to the WMS via the RF session. In step S105 the WMS receives the location data and prompts user for location contents validation entry. In step S209 the LPNs in location are acquired using the drone scanning device and the result is entered into the RF session. In step S110 the WMS receives the LPN data and reconciles against an expected result the WMS then prompts the user for SKU. In step S210 the drone scanning device acquires SKUs on the LPN and enters results into WMS RF session. In step S116 the WMS receives the SKU data and reconciles against an expected result, the WMS then prompts the user for the LPN attributes. In step S211 the drone scanning device acquires the LPN attributes on the LPN and enters the results into the WMS RF session. In step S118 the WMS receives the attribute data and reconciles it against an expected result. In step S108 the WMS assigns a next cycle count task to user and in step S208 the user receives the next cycle count task on the RF session via the drone system.

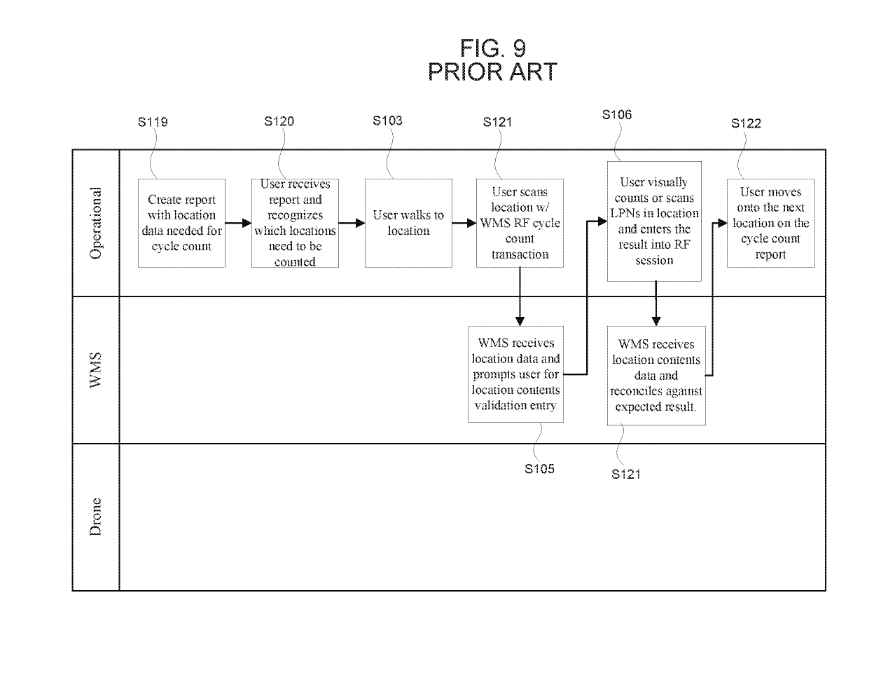

FIG. 9 is a prior art illustration of a cycle counting process. In step S119 a report is created with location data needed for a cycle count. In step S120 a user receives the report and recognizes which locations need to be cycle counted. In step S103 the user walks to the location and in step S121 the user scans the location with a WMS RF cycle count transaction. In step S105 the WMS receives the location data and prompts the user for the location contents validation entry. In step S106 the user visually counts or scans the LPNs in the location and enters the result into the RF session. In step S121 the WMS receives the location contents data and reconciles the data against an expected result. In step S122 the user moves onto the next location on the cycle count report.

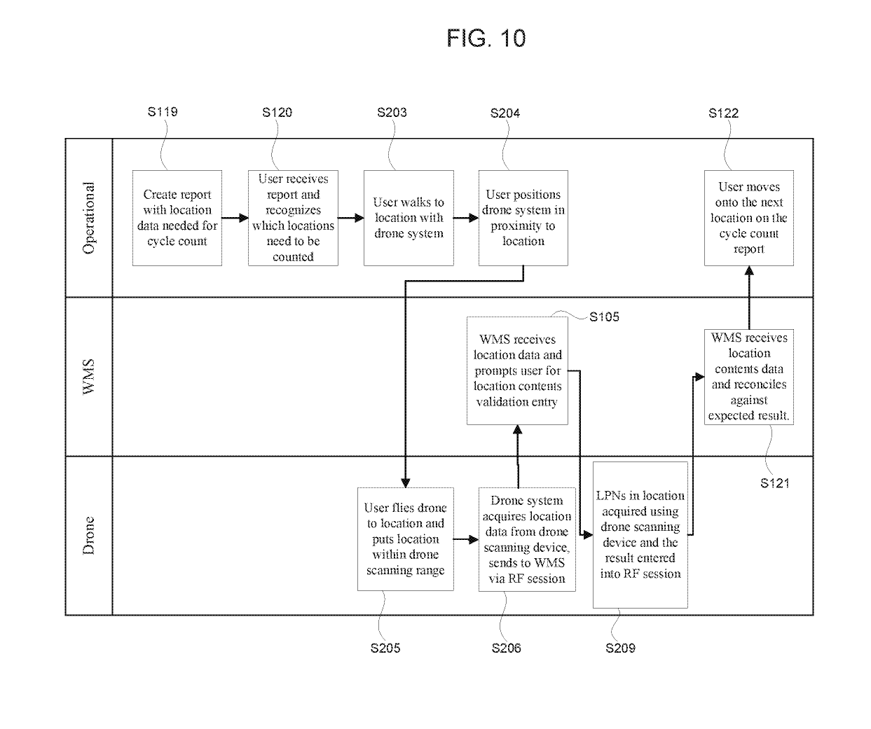

FIG. 10 is a further embodiment of the method of warehouse cycle counting using a drone. In step S119 a WMS a report is created with location data needed for cycle count. In step S120 a user receives the report and recognizes which locations need to be counted. In step S203 the user walks to the location with the drone system. In step S204 the user positions the drone system in proximity to the location. In step S205 the user flies the drone to the location identifier and puts location identifier within drone scanning range. In step S206 the drone system acquires the location data from the drone scanning device and sends the data to the WMS via the RF session. In step S105 the WMS receives the location data and prompts the user for the location contents validation entry. In step S209 LPNs in the location are acquired using the drone scanning device and the result is entered into RF session. In step S121 the WMS receives the location contents data and reconciles it against an expected result. In step S122 the user moves onto the next location on the cycle count report.

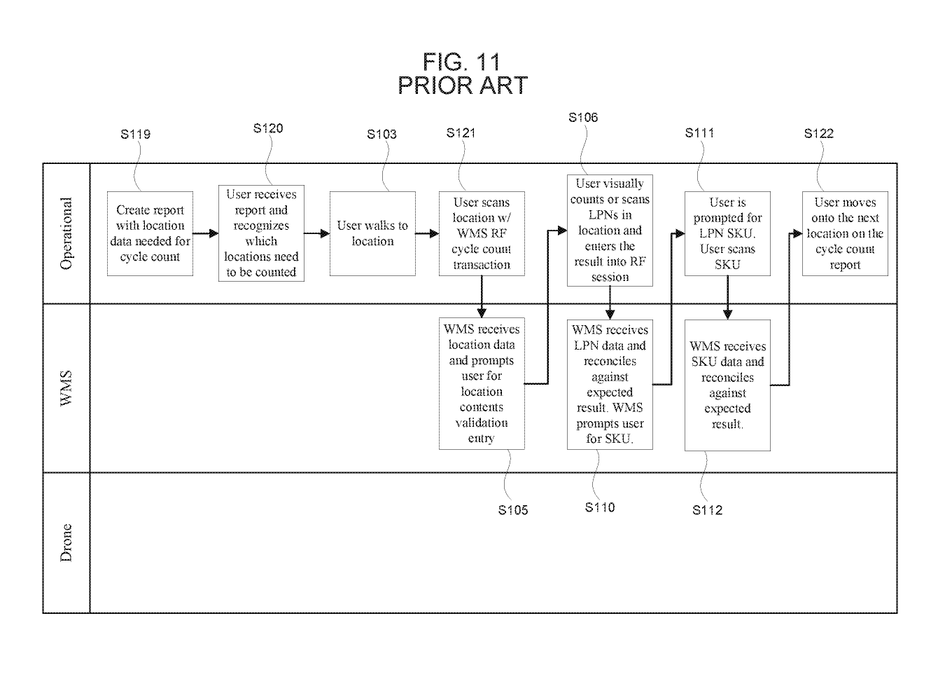

FIG. 11 is a prior art illustration of a cycle counting process. In step S119 a report is created with location data needed for a cycle count. In step S120 the user receives the report and recognizes which locations need to be counted. In step S103 the user walks to the location and in step S121 the user scans the location with the WMS RF cycle count transaction. In step S105 the WMS receives the location data and prompts the user for the location contents validation entry. In step S106 the user visually counts or scans the LPNs in the location and enters the result into the RF session. In step S110 the WMS receives the LPN data and reconciles the date against an expected result, the WMS then prompts the user for the SKU data. In step S111 the user is prompted for the LPNs SKU and the user scans the SKU. In step S112 the WMS receives the SKU data and reconciles the data against an expected result. In step S122 the user moves onto the next location on the cycle count report.

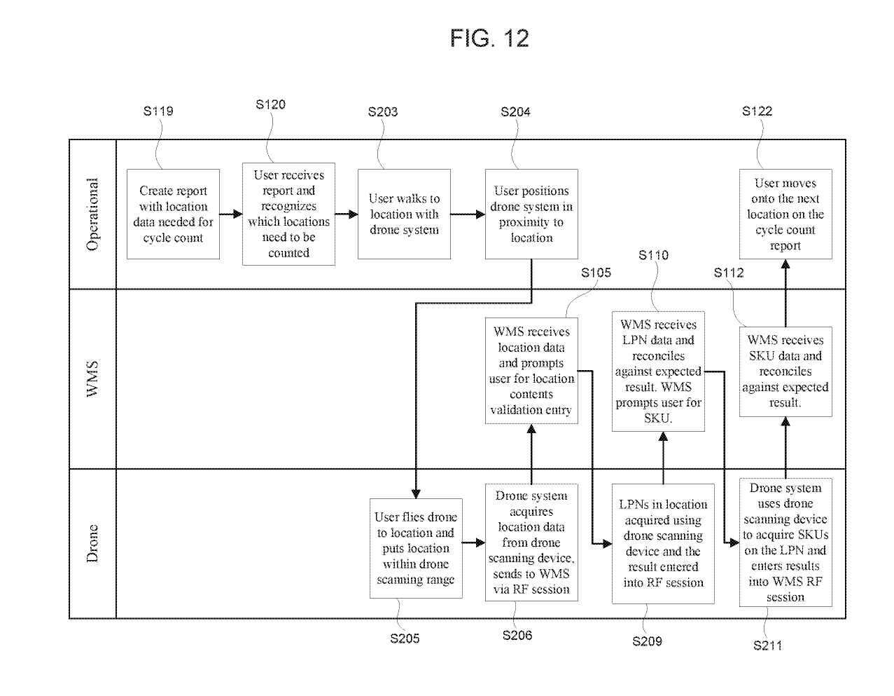

FIG. 12 is a further embodiment of the method of warehouse cycle counting using a drone. In step S119 a report is created with location data needed for a cycle count. In step S120 the user receives the report and recognizes which locations need to be counted. In step S203 the user walks to the location with drone system. In step S204 the user positions the drone system in proximity to the location. In step S205: User flies drone to the location identifier and puts location identifier within the drone scanning range. In step S206 the drone system acquires the location data from the drone scanning device and sends the data to the WMS via RF session. In step S105 the WMS receives the location data and prompts the user for the location contents validation entry. In step S209 the LPNs in the location acquired using the drone scanning device and the result is entered into the RF session. In step S110 the WMS receives the LPN data and reconciles it against an expected result and then the WMS prompts the user for SKU data. In step S211 the drone scanning device acquires the SKUs on the LPN and enters the results into the WMS RF session. In step 8112 the WMS receives the SKU data and reconciles it against an expected result. In step S122 the user moves onto the next location on the cycle count report.

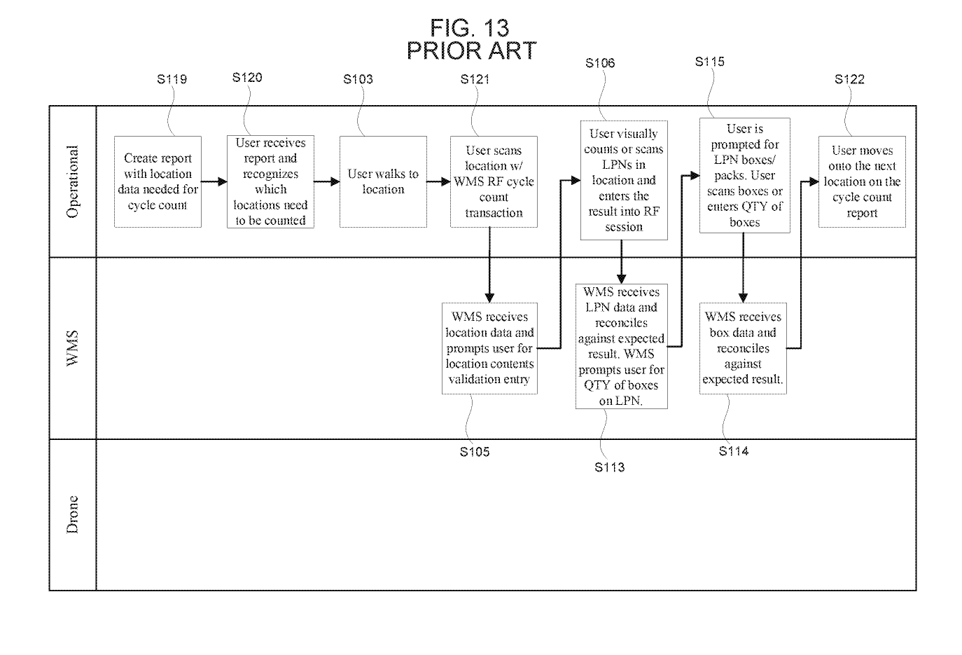

FIG. 13 is a prior art illustration of a cycle counting process. In step S119 a report is created with location data needed for a cycle count. In step S120 the user receives the report and recognizes which locations need to be cycle counted. In step S103 the user walks to the location and in step S121 the user scans the location with the WMS RE cycle count transaction. In step S105 the WMS receives location data and prompts user for location contents validation entry. In step S106 the user visually counts or scans the LPNs in the location and enters the result into the RF session. In step S113 the WMS receives the LPN data and reconciles it against an expected result, and then the WMS prompts the user for a quantity of boxes on the LPN. In step S114 the user is prompted for LPN boxes/packs data then the user scans the boxes/packs or enters quantity of boxes/packs. In step S115 the WMS receives the box/packs data and reconciles it against an expected result. In step S122 the user moves onto the next location on the cycle count report.

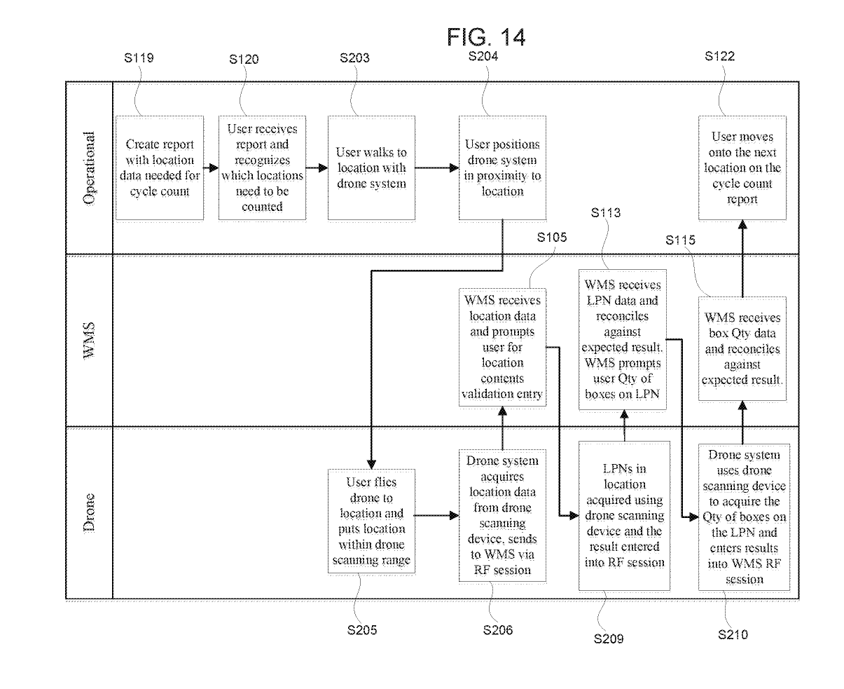

FIG. 14 is a further embodiment of the method of warehouse cycle counting using a drone. In step S119 a report is created with the location data needed for a cycle count. In step S120 the user receives the report and recognizes which locations need to be cycle counted. In step S203 the user walks to the location with drone system, and in step S204 the user positions the drone system in proximity to location. In step S205 the user flies the drone to the location identifier and puts the location identifier within the drone's scanning range. In step S206 the drone system acquires the location data from drone scanning device and sends it to the WMS via RF session. In step S105 the WMS receives the location data and then prompts the user for the location contents validation entry. In step S209 the LPNs in the location are acquired using the drone scanning device and the result is entered into RF session. In step S113 the WMS receives the LPN data and reconciles it against an expected result, and then the WMS prompts the user for a quantity of boxes on the LPN. In step S210 the drone scanning device acquires the quantity of boxes on the LPN and enters the results into the WMS RF session. In step S115 the WMS receives the box data and reconciles it against an expected result. In step S122 the user moves onto the next location on the cycle count report.

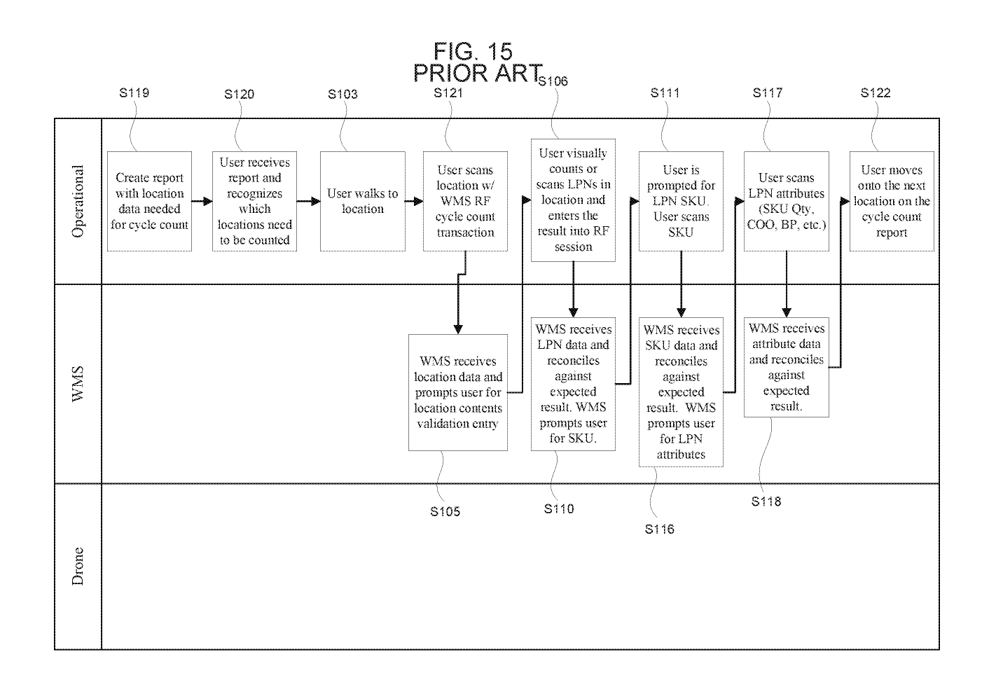

FIG. 15 is a prior art illustration of a cycle counting process. In step S119 a report is created with the location data needed for a cycle count. In step S120 the user receives the report and recognizes which locations need to be cycle counted. In step S103 the user walks to the location and in step S121 the user scans the location with the WMS RF cycle count transaction. In step S105 the WMS receives the location data and prompts the user for the location contents validation entry. In step S106 the user visually counts or scans LPNs in the location and enters the result into the RF session. In step S110 the WMS receives the LPN data and reconciles it against an expected result, and then the WMS prompts the user for SKU data. In step S111 the user is prompted for the LPN SKU and the user scans the SKU. In step S116 the WMS receives the SKU data and reconciles it against an expected result, and then the WMS prompts the user for the LPN attributes. In step S117 the user scans the LPN attributes (SKU Qty, COO, BP, etc.), and in step S118 the WMS receives the attribute data and reconciles it against an expected result. In step S122 the user moves onto the next location on the cycle count report.

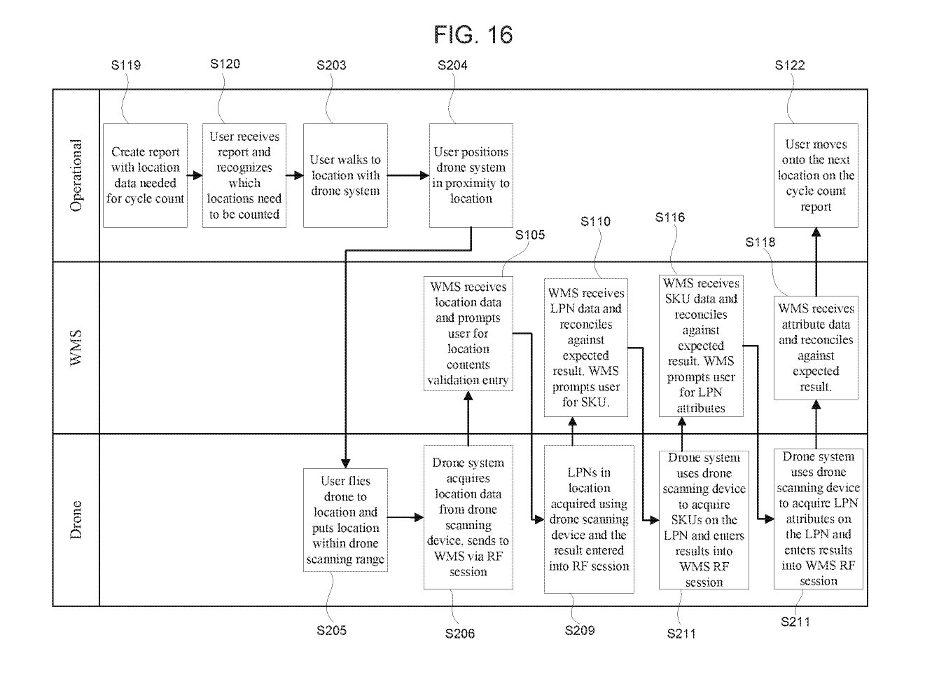

FIG. 16 is a further embodiment of the method of warehouse cycle counting using a drone. In step S119 the WMS, the user or a standalone application (a non-WMS system using data from the WMS) creates a report with the location data needed for a cycle count. In step S120 the user receives the report and recognizes which locations need to be cycle counted. In step S203 the user walks to the location with drone system, and in step S204 the user positions the drone system in proximity to the location. In step S205 the user flies the drone to the location identifier and puts the location identifier within the drone's scanning range. In step S206 the drone system acquires the location data from drone scanning device and sends the data to the WMS via the RF session. In step S105 the WMS receives the location data and prompts the user for location contents validation entry. In step S209 the LPNs in the location are acquired using the drone scanning device and the result is entered into the RF session. In step S110 the WMS receives the LPN data and reconciles it against an expected result, and the WMS prompts user for SKU. In step S211 the drone scanning device acquires the SKUs on the LPN and enters results into the WMS RF session. In step S116 the WMS receives the SKU data and reconciles it against an expected result, the WMS then prompts the user for the LPN attributes. In step S211 the drone scanning device acquires the LPN attributes on the LPN and enters the results into the WMS RF session. In step S118 the WMS receives the attribute data and reconciles it against an expected result. In step S122 the user moves onto the next location on the cycle count report.

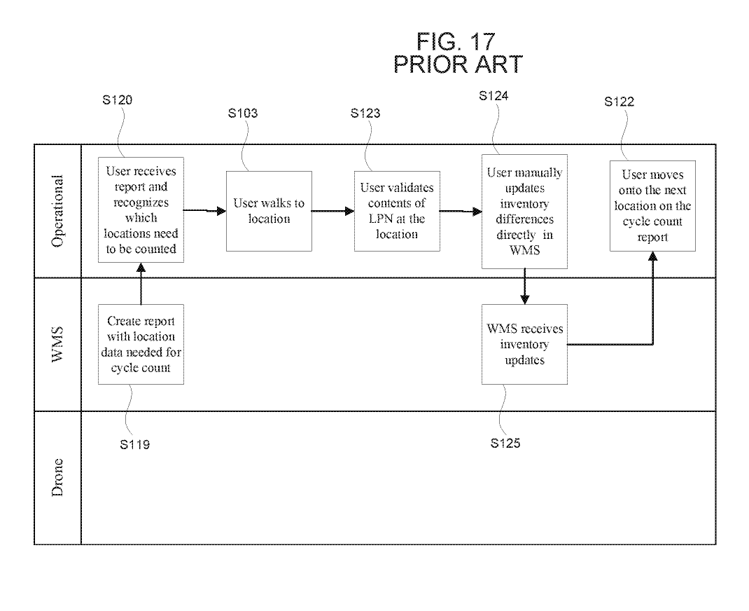

FIG. 17 is a prior art illustration of a cycle counting process. In step S119 a report is created by the WMS with the location data needed for a cycle count. In step S120 the user receives the report and recognizes which locations need to be cycle counted, and in step S103 the user walks to the location. In step S123 the user validates contents of LPN at the location. In step S124 the user manually updates inventory differences directly in the WMS. In step S125 the WMS receives inventory updates, and in step S122 the user moves onto the next location on the cycle count report.

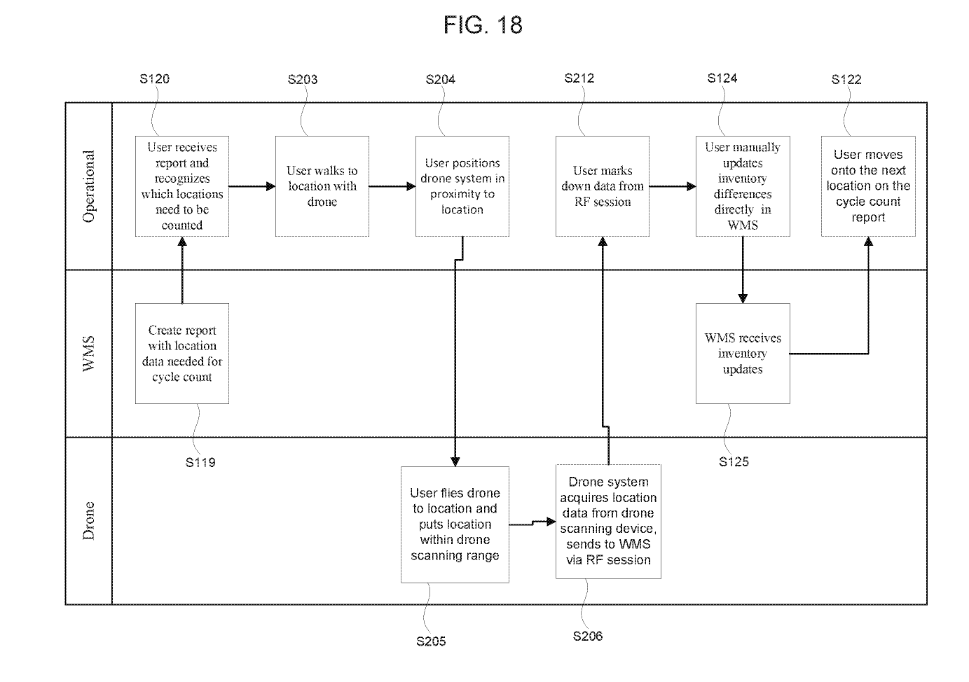

FIG. 18 is a further embodiment of the method of warehouse cycle counting using a drone. In step S119 the WMS, the user or a standalone application (a non-WMS system using data from the WMS) creates a report with the location data needed for a cycle count. The report can be printed or in digital form. In step S120 the user receives the report and recognizes which locations need to be counted. In step S203 the user walks to the location with the drone system. In step S204 the user positions the drone system in proximity to location. In step S205 the user flies the drone to the location identifier and puts the location identifier within the drone's scanning range. In step S206 the drone system acquires the location data from the drone scanning device and sends the data to the WMS via the RF session. In step S212 the user marks down the data from RF session, and in step S124 the user manually updates the inventory differences directly in the WMS. In step S125 the WMS receives the inventory updates, and in step S122 the user moves onto the next location on the cycle count report.

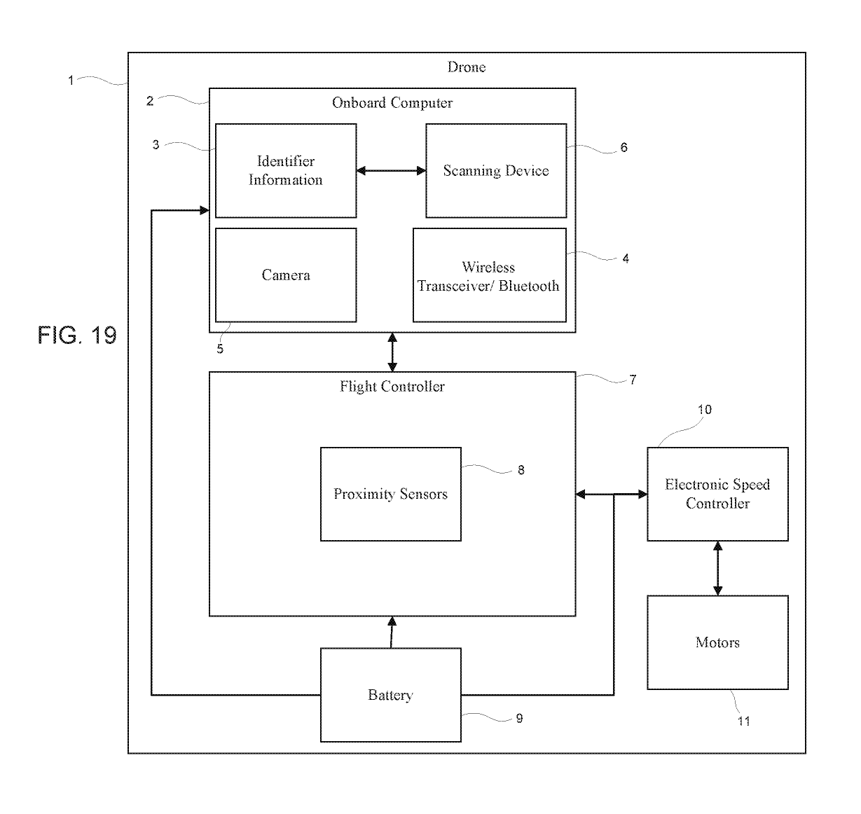

FIG. 19 illustrates the components of a drone used for a drone system embodiment. The drone 1 has an onboard computer 2 comprising identifier information 3, a wireless Transceiver/Bluetooth 4, a camera 5, and a scanning device 6. The identifier information 3 is the stored information from the scanning device 6. The scanning device 6 can be a barcode scanner, and RFID reader, a camera for the user to visually scan The onboard computer 2 interacts with a flight controller 7 having proximity sensors 8. The flight controller 7 connects to an electronic speed controller ESC 10 which interacts with the drone's motors 11. A battery 9 connects to the onboard computer 2, the flight controller 7, and the ESC 10.

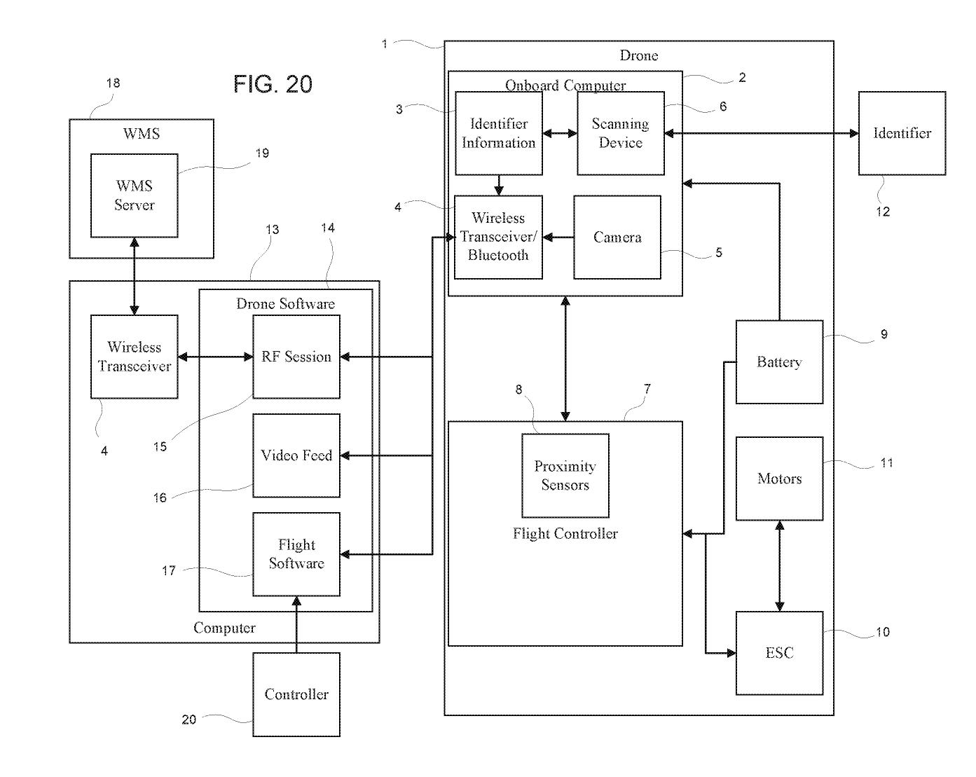

FIG. 20 is a schematic drawing of an embodiment of the warehouse management system and drone system used for these methods of warehouse cycle counting using a drone. The user connects to the WMS 18 through an RF session that is accessed on the drone system computer 13. The computer 13 has drone software 14 which comprises the flight software 17, video feed 16, and the RF session 15. The RF session 15 interacts with the computer's 13 wireless transceiver/Bluetooth 4. The wireless transceiver/Bluetooth communicates with the WMS server 19 of the WMS 18. The drone system controller 20 connects to the flight software 17 of the computer 13. The wireless transmitted on the drone's 1 onboard computer 2 communicates with the flight software 17, video feed 16, and the RF session 15. The drone 1 has an onboard computer 2 comprising identifier information 3, a wireless transceiver/Bluetooth 4, a camera 5, and a scanning device 6. The onboard computer 2 interacts with a flight controller 7 having proximity sensors 8. The flight controller 7 connects to an electronic speed controller ESC 10 which interacts with the drone's motors 11. A battery 9 connects to the onboard computer 2, the flight controller 7, and the ESC 10. The scanning device 6 scans the identifier 12. The identifier 12 can be the location identifier (barcode. RFID, or alpha-numeric or symbol display representing the location within a warehouse) or the inventory data (barcode. RFID, or alpha-numeric or symbol display of LPNs, SKUs, boxes/packs, LPN attributes, COO, BP, etc.). The scanning device sends the information to through the identifier information 3, to the wireless transceiver/Bluetooth 4, which populates the RF session 15 to the WMS 18 via the wireless transceiver/Bluetooth 4 and the WMS server 19. A user flies the drone 1 using the controller 20 attached to the computer 13 that is integrated with the flight software 17. The flight software sends commands to the drone through a wireless transceiver/Bluetooth 4 attached to the onboard computer 2. The onboard computer 2 sends the commands to the flight controller 7 that relays the controls to the electronic speed controllers 10 which controls the motors 11 The onboard computer 2 has a camera 5 attached to it that streams live video back to the computer 13 in which the user uses to fly the drone 1.

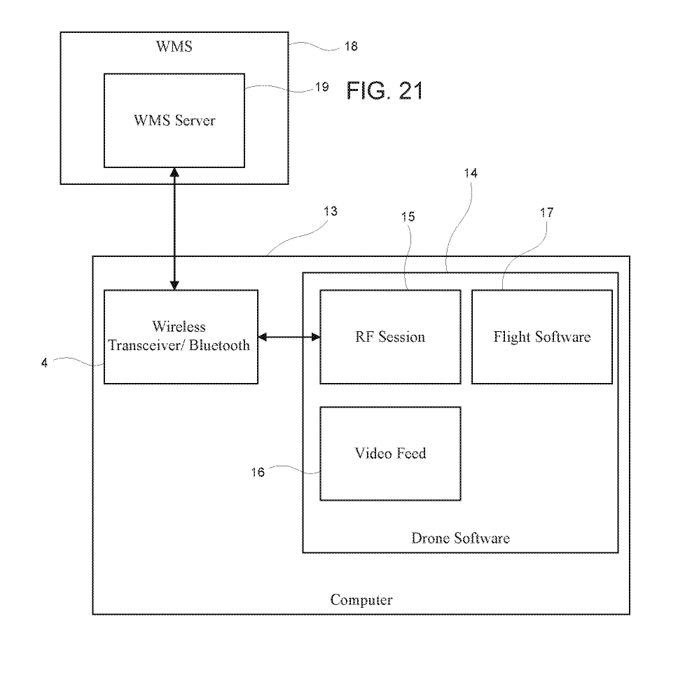

FIG. 21 illustrates how the warehouse management system WMS 18 interacts with the RF session 15. The WMS 18 application utilizes a server 19 to communicate to outside systems. A user connects to the WMS 18 using an RF session 15. The RF session 15 is configured to connect to the WMS system 18. In FIG. 21, the RF session 15 connects to the WMS 18 via the wireless transceiver/Bluetooth 4 on the computer 13. Once logged into the RF session 15, the user is able to communicate with the WMS 18. The RF session is part of the drone software 14 on the computer 13 along with the video feed 16 and the flight software 17.

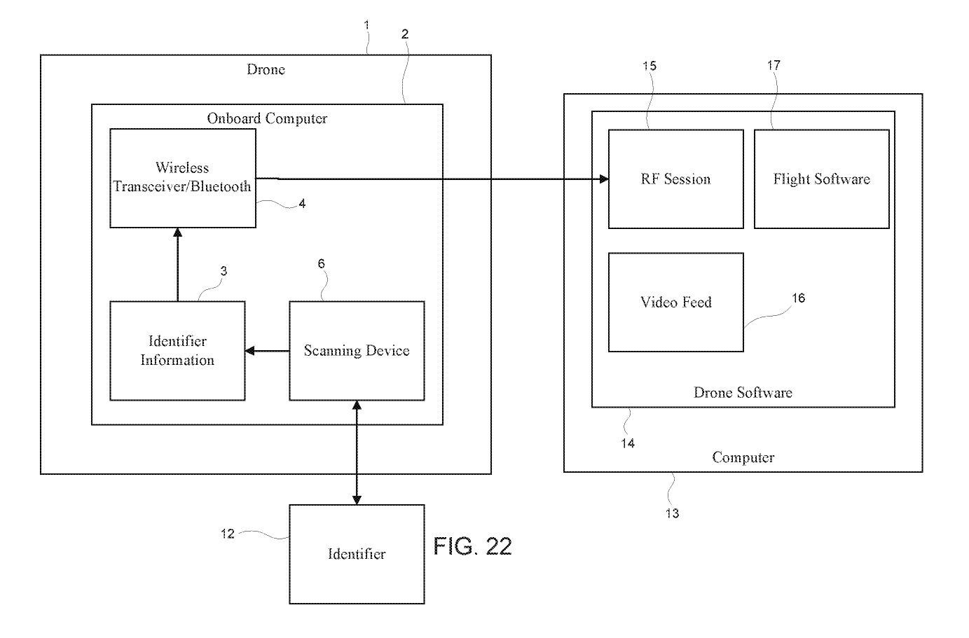

FIG. 22 illustrates an embodiment of how the drone 1 populates the RF session 15 after scanning the identifier 12. A user flies the drone 1 and positions the scanning device 6 of the drone 1 to scan a location or inventory identifier 12. Upon successfully acquiring a location or inventory identifier 12, the identifier information 3 is stored in the onboard computer 2. The onboard computer sends the identifier information 3 via a wireless transceiver/Bluetooth 4 to a RF session 15 that is connected to the WMS server 19 (not shown).

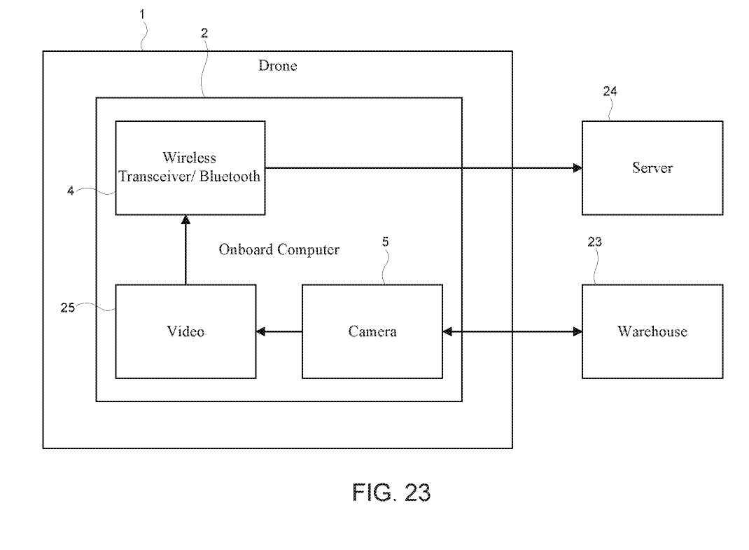

FIG. 23 illustrates an embodiment of the drone 1 transmitting video 25 to a server 24. The user flies the drone 1 to a location in the warehouse 23. A camera 5 attached to the drone's onboard computer 2 streams video back to a server through the wireless transceiver/Bluetooth 4 attached to the onboard computer 2.

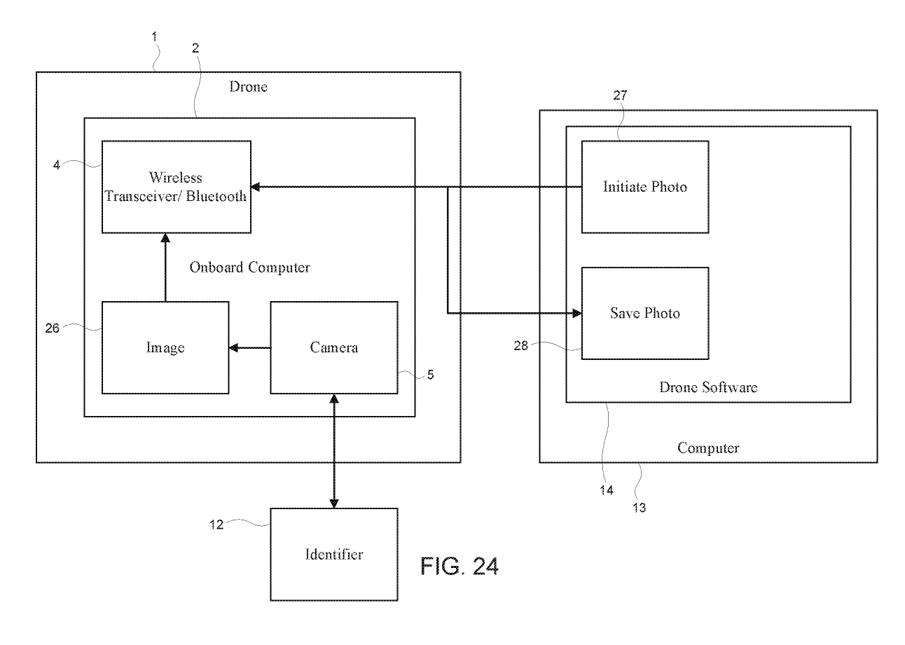

FIG. 24 illustrates an embodiment of the drone 1 taking still images 26 of the identifier 12 and transmitting them to a server 24 (not shown). The user flies the drone 1 to the location in the warehouse 23 (not shown). A camera 5 attached to the drone's onboard computer 2 takes still images 26 as the scanning device 6 scans the identifier 12. The still image 26 is sent from the onboard computer 2 to a server 24 via a wireless transceiver/Bluetooth 4 through the drone software 14 on the computer 13.

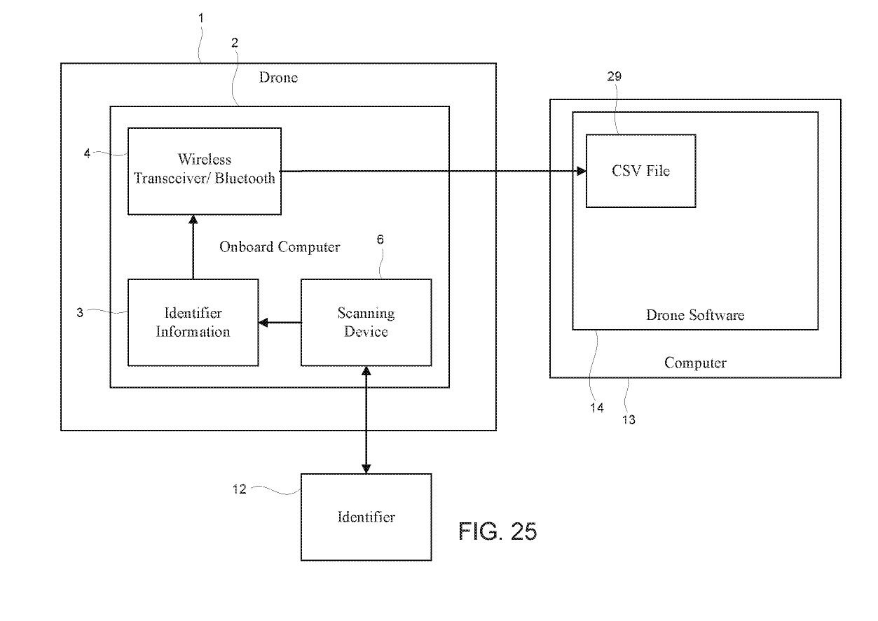

FIG. 25 illustrates the onboard computer 2 storing identifier information 3 in CSV format 29 and exporting the file to a server 24 (not shown). The user flies the drone 1 to a location in the warehouse 23 (not shown). A camera 5 attached to the drone's onboard computer 2 streams video 25 back to a server 24 through the wireless transceiver/Bluetooth 4 attached to the onboard computer 2. Upon successfully scanning an identifier 12, the identifier information is stored in the computer 13 in a CSV file 29. Successive identifier 12 scans are saved in the same CSV file 29. Once the user completes the cycle counting tasks, the user can export the CSV file 29 to the server 24.

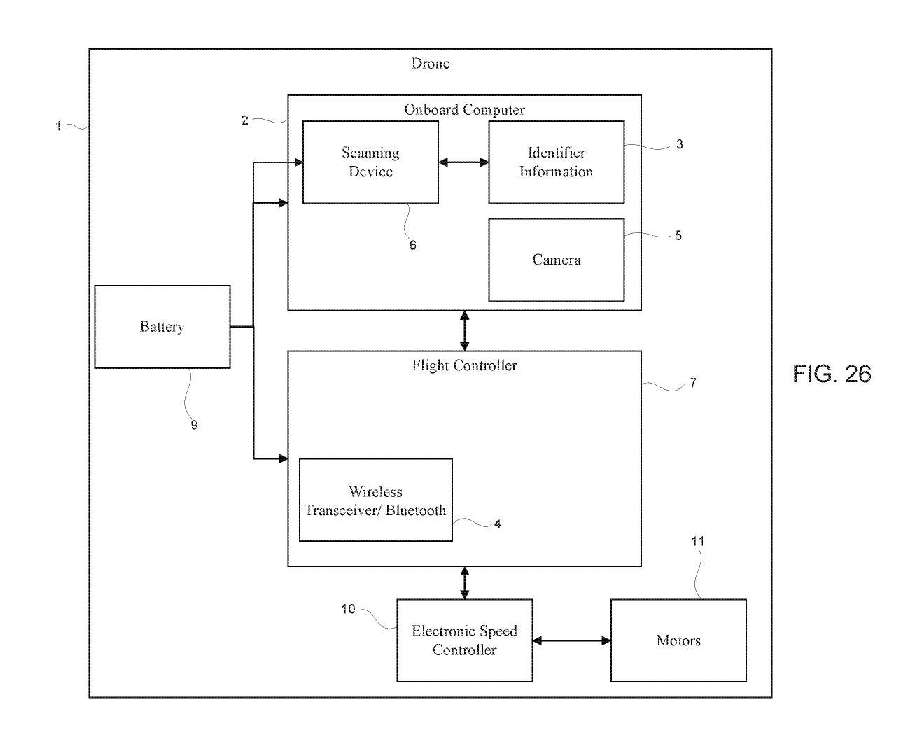

FIG. 26 is a schematic drawing of an embodiment of the drone 1 components with scanning device 6. The drone system is comprised of an onboard computer 2 and flight controller 7. The battery 9 is attached to the flight controller 7 and to the onboard computer 2. The camera 5 and the scanning device 6 are attached to the onboard computer 2. The onboard computer 2 stores the identifier information 3 from identifiers 12 (not shown) acquired by the scanning device. The flight controller 7 connects to the electronic speed controllers 10 which are connected to the motors 11 that allow the drone 1 to fly. The drone 1 communicates to a computer 13 (not shown) via the wireless transceiver/Bluetooth 4 that is attached to the flight controller 7.

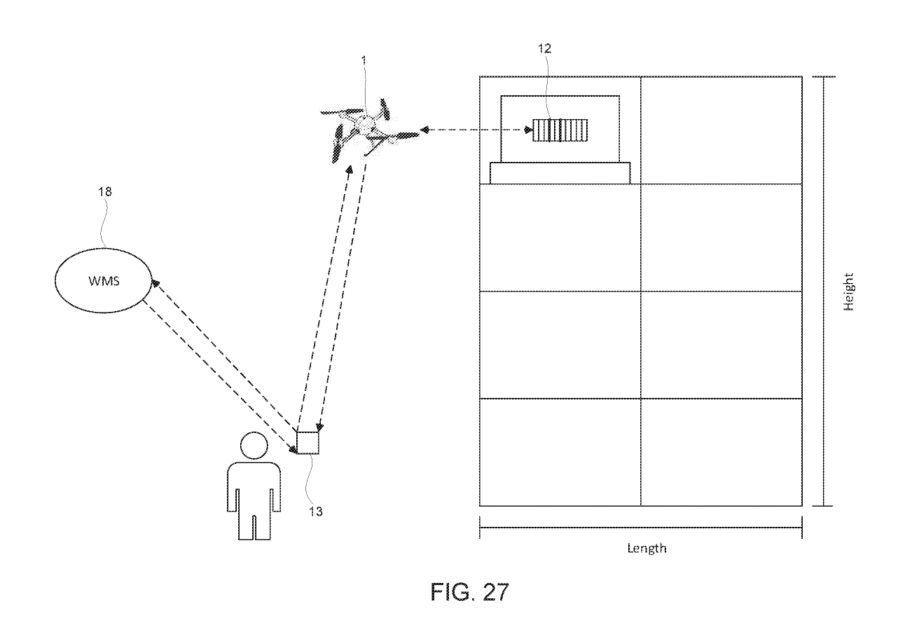

FIG. 27 is a diagrammatic illustration of the method of warehouse cycle counting using a drone. A user operates the computer 13, which communicates with the drone 1 and the WMS 18. The user flies the drone 1 to scan a location identifier 12, the location data is sent through the RF session 15 on the computer 13 to the WMS 18, and once prompted the user then scans the content identifier 12 of that location, which populates the RF session 15 on the computer 13 and transmitted to the WMS 18. Depending on the requests of the WMS, the user can scan all need location and inventory information (barcode. RFID, or alpha-numeric or symbol display of LPNs, SKUs, boxes/packs, LPN attributes, COO. BP, etc.).

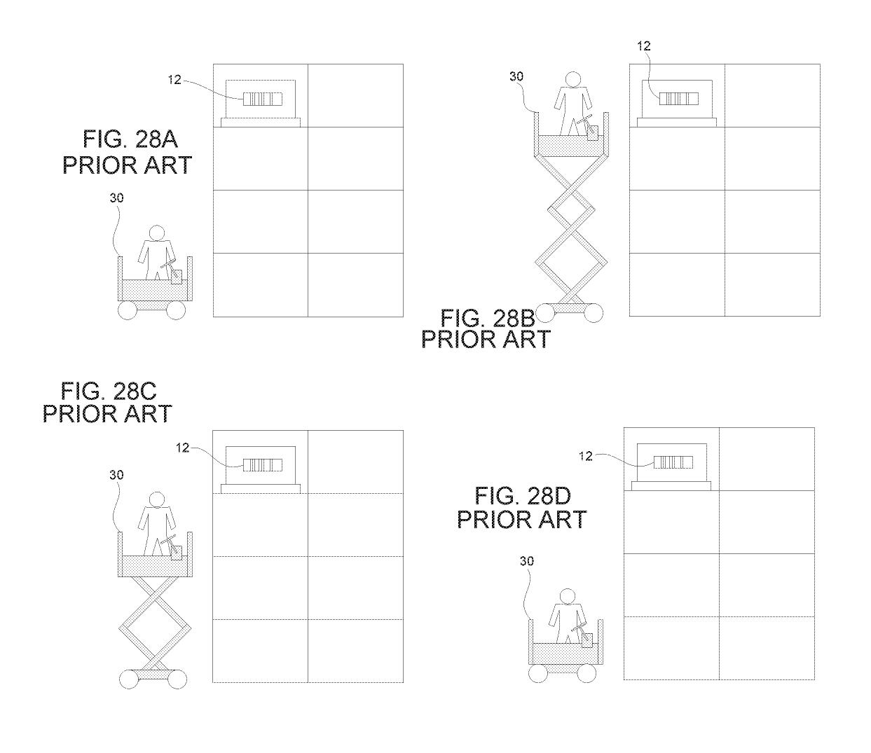

FIGS. 28A-D illustrates a prior art method of cycle counting in which a user utilizes a lift truck 30 to reach a warehouse location to scan the location and contents identifier 12 of the inventory location.

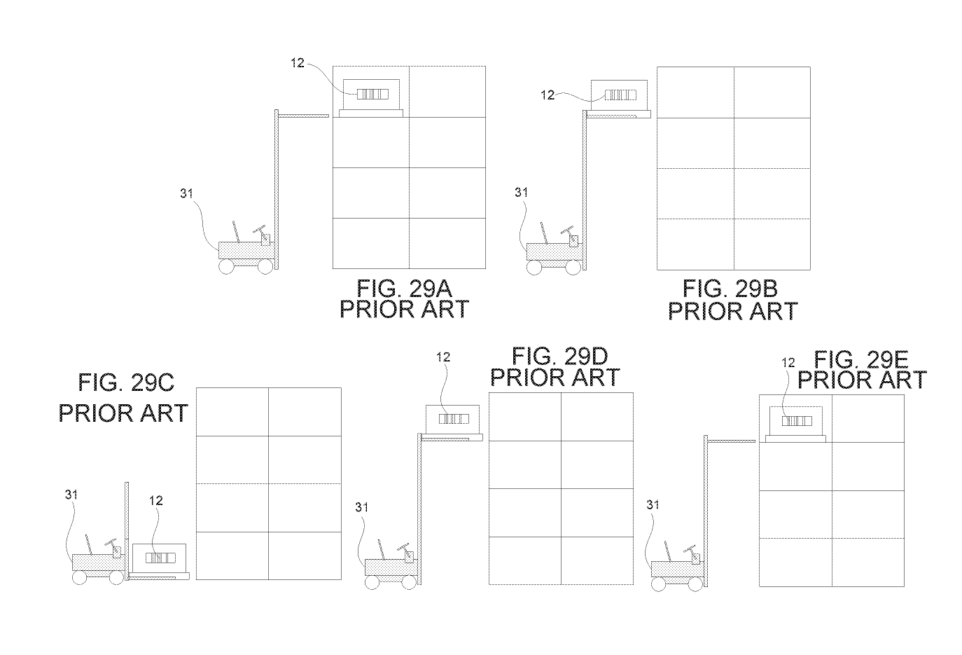

FIGS. 29A-E illustrates a prior art method of using a fork lift 30 to lower and re-place a pallet from a warehouse storage location in order to scan the inventory identifier 12 of the pallet.

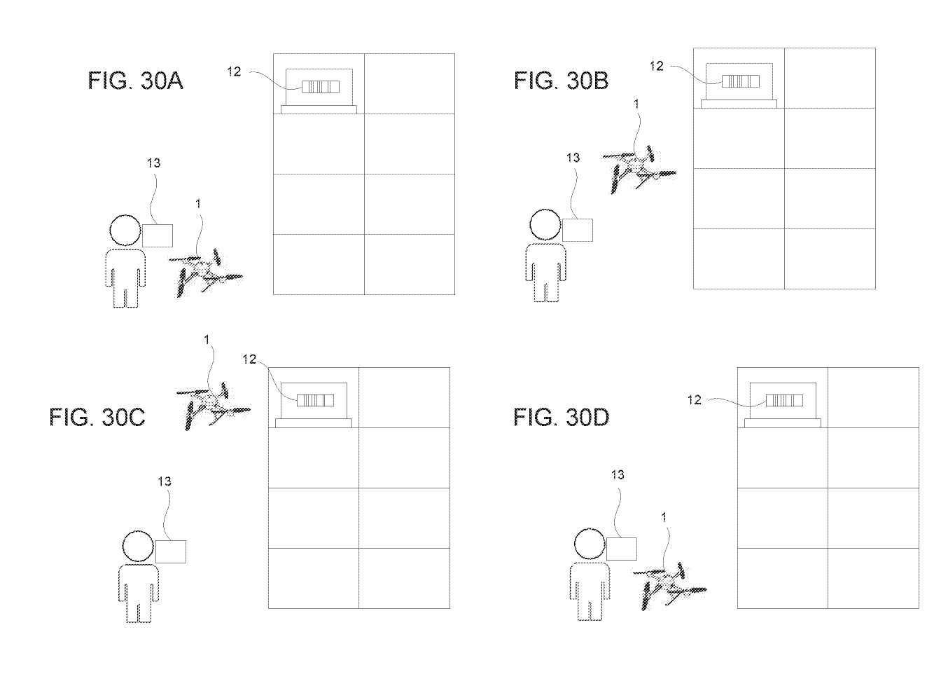

FIGS. 30A-D illustrate an embodiment of a method of warehouse cycle counting using a drone. The user flies the drone 1 with a computer 13 to a location and contents identifier 12 to fulfill cycle counting task.

An alternative embodiment for autonomous drone flight using Bluetooth beacons can be integrated into the invention. The ability navigate an unmanned vehicle indoors is restricted by the ability for wireless devices including GPS and wifi to communicate. BLE Beacons are lightweight, small and low cost devices that transmit data in the form of Bluetooth beacon frames at pre-defined intervals. The transmission is able to be detected by a receiver in close proximity to the beacon, typically 70 meters. The unmanned drone can be autonomously operated throughout a warehouse by using a combination of image recognition software and Bluetooth Low Energy (BLE) beacons. BLE beacons are used for macro navigation of the unmanned drone while the image recognition enables the micro navigation of the unmanned drone. Image recognition is a field that includes methods for acquiring, processing, analyzing, and understanding images and, in general, high-dimensional data from the real world in order to produce numerical or symbolic information, e.g., in the forms of decisions.

The ratio of macro navigation (BLE beacon) to micro (image recognition) navigation is dependent upon the specific ability of the image recognition software in a specific distribution center. In some cases the process includes timed movements at a specific power of the unmanned vehicle to position the vehicle at a location where the image recognition can understand the surroundings. To enable the image recognition predefined image recognition patters would be comprised of the systematic understanding of standard physical features in a distribution center such as racking, pallets, rows of pallets and other common physical features. The autonomous drone can be programmed to execute the navigation program for each specific physical feature, while the BLE beacons would be used to initiate the programming for a predefined image recognition navigation program. The BLE beacons are placed between the differing common warehouse features and act as a starting point for the new image recognition program.

For example, when an unmanned vehicle is using image recognition to navigate a bulk row of pallets and then needs to transition to navigating a rack system, there is a BLE beacon between the bulk locations and rack locations that stops the unmanned vehicle, stops the bulk image recognition program, calibrates it to the physical location in the warehouse, initiates the rack image recognition program, and starts the unmanned vehicle's navigation of the rack locations.

The BLE beacons can be configured with a large and boldly colored backdrop to locate a drone to a specific physical location in a distribution center. The image recognition software understands all possible physical features in a distribution center and calculates the navigation commands for an unmanned drone to navigate through the physical features. The navigation system can be configured to use multiple (3 or more) BLE beacons to enable a triangulation calculation to determine the location of the drone. A benefit to using the BLE technology over a WiFi system would be lower cost, size and their battery operated function, which allows a greater amount to be placed throughout the warehouse. The image recognition programs can be run on the local processing device on the unmanned vehicle or processed on a server which then communicates the telemetry movements to the unmanned vehicle.

1. A method of warehouse cycle counting, comprising the following steps:
providing a drone system with a drone carrying a scanning device selected from the group consisting of a barcode scanner, video feed, image recognition, and RFID scanner, and a computer with an RF session;
receiving, by the computer, a cycle count task on the RF session;
placing the drone system within a flight range of the drone to a cycle count location;
flying the drone to the cycle count location of the cycle count task;
acquiring inventory location data using the scanning device;
sending the inventory location data to a warehouse management system (WMS) via the RF session;
acquiring inventory data at the inventory location using the scanning device;
sending the inventory data to the WMS via the RF session;
if prompted by the WMS, acquiring further data selected from the group consisting of SKU data, LPN attribute information, and quantity information.

2. The method according to claim 1, wherein the receiving step comprises receiving the cycle count task from a system selected from the group consisting of the WMS and non-WMS system or process to generate a report.

3. The method according to claim 1, further comprising sending the inventory data to the WMS via RF prompts. staging tables, XML, socket (TCP/IP), file transfer protocol (FTP), or flat file.

4. The method according to claim 1, further comprising the step of inspecting the physical condition of the inventory or other materials by viewing the physical condition of inventory or other materials in a warehouse via video streamed from a camera on the drone.

5. The method according to claim 1, further comprising the step of taking a photograph of identifier information initiated at the controller or automatically as the scanning device scans the identifier information, and storing the image.

6. The method according to claim 1, further comprising the step of storing or broadcasting a video stream of a drone flight path on the computer.

7. The method according to claim 1, further comprising the step of storing the scanned inventory location and inventory data as a .csv or other spreadsheet format file on the computer.

8. The method according to claim 1, further comprising directing the warehouse cycle counting with a cycle counting software system configured to:
determine which warehouse locations should be cycle counted;
receive data points of cycle counting tasks from the WMS or from a user-generated report;
assign each location a rank based on the received data points; and
creates a report for which locations in the warehouse should be cycle counted.

9. The method according to claim 1, further comprising directing the warehouse cycle counting with a cycle counting algorithm system configured to:
determine which warehouse locations should be cycle counted;
generate a cycle counting report from cycle counting software;
send a report to the WMS to generate cycle counting tasks for a user;
generate in the WMS cycle counting tasks that are assigned to users; and
causing a user to conduct the cycle counting tasks in the warehouse.

10. An apparatus for warehouse cycle counting comprising:
a drone system with a drone and a computer;
the drone having an onboard computer, a flight controller, electronic speed controllers, and a battery;
the onboard computer having a scanning device selected from the group consisting of a barcode scanner, video feed, image recognition, and RFID scanner, a camera, a wireless transceiver or Bluetooth device, and a memory for identifier information storage;
the flight controller having proximity sensors
the electronic speed controllers (ESC) connecting to motors that propel the drone;
the battery powering the ESC, flight controller, and onboard computer;
the computer having drone software, a controller, and a wireless transceiver for communication with the drone and a warehouse management system (WMS); and
the drone software having flight software, a video feed, and an RF session.

11. The drone system according to claim 10, further comprising a cart having a drone landing pad.

12. The drone system according to claim 10, wherein said drone comprises propellers and guards around the propellers.

13. The drone system according to claim 10, wherein said drone comprises LED lights to illuminate inventory and inventory location identifiers.

14. The drone system according to claim 10, wherein said computer has custom software configured for communication between said drone, the WMS, and a network.

15. The drone system according to claim 10, further comprising a cycle counting software system configured to:
determine which warehouse locations should be cycle counted;
receive data points of cycle counting tasks from the WMS or from manual input;
assign each location a rank based on the received data points; and
creates a report for which locations in the warehouse should be cycle counted.

16. The method according to claim 10, further comprising a cycle counting algorithm system configured to:
determine which warehouse locations should be cycle counted;
generate a cycle counting report from cycle counting software;
send a report to the WMS to generate cycle counting tasks for a user;
generate in the WMS cycle counting tasks that are assigned to users; and
causing a user to conduct the cycle counting tasks in the warehouse.
